(19) United States
(12) Patent Application Publication
(10) Pub. No.: US 2010/0284840 A1
(43) Pub. Date: Nov. 11, 2010

(54) Fuel Pump

(75) Inventor: Holger Wehner, Bad Soden-Altenhain (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/743,704

(22) PCT Filed: Nov. 10, 2008
(86) PCT No.: PCT/EP2008/065241

§ 371 Date: May 19, 2010

(30) Foreign Application Priority Data
Nov. 20, 2007 (DE) 10 2007 055 380.5

(51) Int. Cl. F02M 37/10

(52) U.S. Cl. 417/410.1

(57) ABSTRACT

A fuel pump having an electric motor and a pump stage driven by the electric motor. The pump stage includes an impeller disposed in a pump housing, and the pump housing having a pump base and a pump cover. The pump cover has an inlet port. The inlet port is thereby designed to be changeable in axial length.

### PRIORITY CLAIM

This is a U.S. national stage of Application No. PCT/EP2008/065241, filed on Nov. 10, 2008 which claims priority to the German Application No.: 10 2007 055 380.5, filed: Nov. 20, 2007, the content of both incorporated herein by reference.

### BACKGROUND OF THE INVENTION

1. Field of the Invention

The invention relates to a fuel pump with an electric motor and a pump stage driven by the electric motor. The pump stage comprises an impeller arranged in a pump housing. The pump housing comprises a pump base and a pump cover, and the pump cover has an intake tube.

2. Related Art

Fuel pumps of the abovementioned type are arranged in a fuel tank of a motor vehicle and have the task of delivering fuel from the fuel tank to an internal combustion engine of the motor vehicle. Fuel pumps of this type have been known for a long time and are therefore prior art. Fuel tanks are typically composed of plastic or metal. They have a low height because of their arrangement in the motor vehicle. This has the result that filling amounts of several liters result only in low filling heights. In order, firstly, to keep the amount of fuel which can no longer be technically drawn off during operation and, secondly, the amount of fuel necessary for a first filling operation as small as possible, it is necessary to arrange the intake tube of the fuel pump at as low a point as possible. However, this is made difficult by manufacturing-induced tolerances in the fuel tanks of up to 25 mm. Another difficulty is that the fuel pumps are generally connected to a flange which closes an installation opening which is arranged on the top side of the fuel tank and through which the fuel pump is inserted into the fuel tank.

For this purpose, it is known to connect the fuel pump to the flange via at least one guide tube, wherein the guide tube has a compression spring pretensioning the fuel pump against the base of the fuel tank. In the case of arrangements in which the fuel pump is arranged in a swirl pot, the guide tubes are connected to the swirl pot and stress the latter against the base of the fuel tank. A disadvantage of said arrangements is the relatively large outlay on the guide tubes with the compression springs. In addition to the increased outlay on installation, receptacles for the guide tubes and supporting points for the compression springs have to be provided on the flange and the fuel pump, or on the swirl pot.

It is furthermore known to arrange a preliminary filter, which filters coarse impurities out of the fuel, on the intake tube of the fuel pump. Preliminary filters of this type have a filter fabric made of metal, fleece or plastic which is arranged around a generally inner supporting body in order to increase the dimensional stability. Preliminary filters are not sufficient to compensate for tolerances because of the relatively rigid supporting body.

### SUMMARY OF THE INVENTION

The invention is based at least in part on providing a fuel pump with which an intake point which is as low as possible is achieved in a fuel tank, where the outlay on achieving a low intake point is to be low.

According to one embodiment of the invention, the object is achieved in that the intake tube is designed to be changeable or variable in its axial length.

By it's the intake tubes length, which is changeable in the axial direction, the intake tube provides the possibility of, firstly, compensating for tolerances in the manufacturing of a fuel tank and, secondly, compensating for changeable fuel tank heights as a result of a changing filling level. The length compensation takes place directly at the intake point. The fuel pump can be connected fixedly to the flange without undertaking additional measures for adaptation to the height-changeable lowest intake point. Since the intake tube and not the weight of the entire fuel pump is adapted to the lowest intake point, the outlay on the adaptation drops considerably.

In one embodiment of the invention, the intake tube has an expansion bellows, preferably made of an elastic material, preferably plastic or rubber. An expansion bellows of this type has the advantage of being fitable relatively simply. In addition, given an appropriate design, the material properties and shaping of the expansion bellows cause its end which faces away from the fuel pump to be prestressed against the base of a fuel tank or a swirl pot without additional components being necessary. An expansion bellows is therefore particularly cost-effective. A further advantage of an expansion bellows made from plastic is that the fuel pump is thereby decoupled from the base of the fuel tank such that the noises from the fuel pump during operation are not radiated into the fuel tank.

In one embodiment of the invention, the intake tube comprises a first fixed element and a second element, the second element being arranged in an axially movable manner with respect to the first element. With this intake tube designed in the manner of a telescopic tube, length compensation can be obtained with little outlay. By a specific selection of the length of the two elements, the fuel pump can be adapted to widely varying use conditions, in particular to fuel tanks having different tolerance ranges. In the simplest case, the two elements are of tubular design.

While the first fixed element is advantageously formed as a single part with the pump cover, the second movable element can be composed of metal, plastic or rubber. The formation of the movable element from plastic or rubber has the advantage that the fuel pump is thereby likewise acoustically decoupled from the base of the fuel tank or the swirl pot. Annoying radiated interference from noises arising from the operation of the fuel pump is thereby avoided.

In order, as a function of the tolerances and the filling levels of the fuel tank, always to reach the lowest intake point with the intake tube, one embodiment comprises arranging a compression spring in the intake tube between the pump cover and the movable element. The compression spring ensures that the movable element is always pressed away by the fuel pump, as a result of which said element is prestressed against the fuel tank when said element rests on the base of the fuel tank or of the swirl pot.

In one embodiment of the invention, the lowest intake point is reached by the movable element being fixedly connected to the base of the fuel tank or to the base of the swirl pot. Such a connection is achieved in a simple manner by a press fit or clip connection. A corresponding receptacle is provided for said connection on the base of the fuel tank or on the base of the swirl pot. The receptacle can be connected as a separate component to the base or can be integrally formed thereon.

In order, firstly, to be able to draw up fuel and, secondly, always to keep the intake tube at the lowest intake point, that end of the movable element or of the expansion bellows which faces away from the fuel pump has axially arranged formations which are distributed at a distance from one another over the circumference of the movable element.

In one embodiment of the invention, that end of the movable element or of the expansion bellows that faces away from the fuel pump is beveled in such a manner that the end is not aligned parallel with the base of the fuel tank or of the swirl pot. The fuel pump is able to suck up fuel via the gap created in this manner between the intake tube and the base.

### BRIEF DESCRIPTION OF DRAWINGS

The invention is explained in more detail with reference to a number of exemplary embodiments. In the figures:

FIGS. 1 and 2 are a fuel pump according to the prior art;

FIG. 3: is a fuel pump according to one embodiment of the invention, and

FIGS. 4-6: are further embodiments of the fuel pump according to the invention.

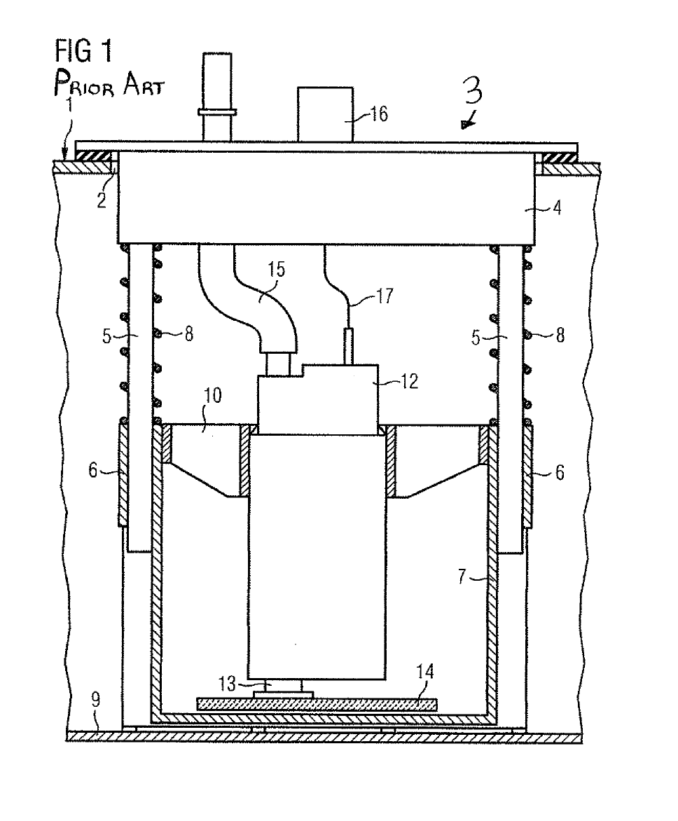

FIG. 1 shows a fuel tank 1 with an installation opening 2 into which a fuel delivery unit 3 is inserted. A flange 4 closes the installation opening 2. Guide tubes 5 that engage in receptacles 6 in a swirl pot 7 are inserted in the flange 4. Between the flange 4 and the swirl pot 7, compression springs 8 prestress the swirl pot 7 against the base 9 of the fuel tank 1, and are arranged in the guide tubes 5. A pump holder 10, in which the fuel pump 12 is held, is fastened in the swirl pot 7. A preliminary filter 14 reaching virtually as far as the base of the swirl pot 7 is fastened to intake tube 13 of the fuel pump 12. The fuel pump 12 drawn up fuel via the preliminary filter 14 and conveys said fuel via a supply line 15 out of the fuel tank 1 to an internal combustion engine (not illustrated) of the motor vehicle. The fuel pump 12 is supplied with power via a connector 16 on the flange 4 and electric lines 17.

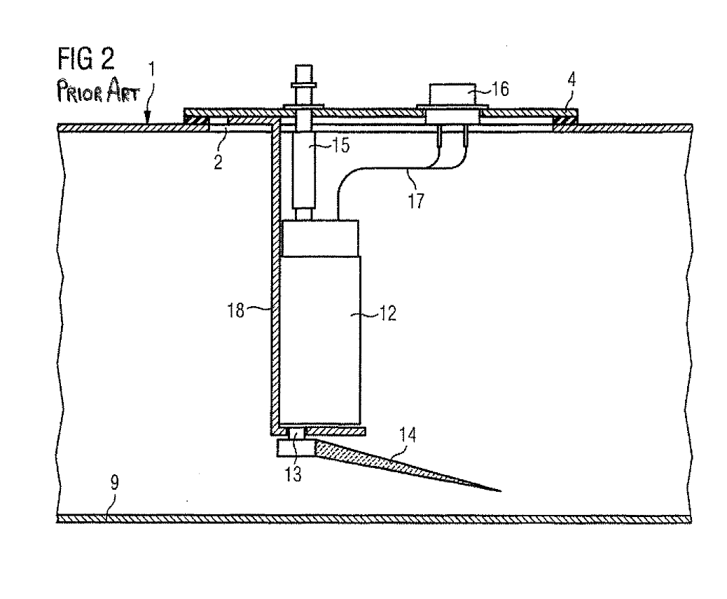

The fuel pump 12 which is shown in FIG. 2 is fastened to a pump holder 18 which, in turn, is arranged on the flange 4. As a result of the rigid pump holder 18 and the likewise relatively rigid preliminary filter 14, the latter does not reach as far as the base of the fuel tank because of tolerances caused by the manufacturing and at high filling levels which lead to the base 9 sagging. If said distance remains because of tolerances, a relatively large amount of fuel is necessary for the first filling operation before the fuel pump 12 can draw up fuel.

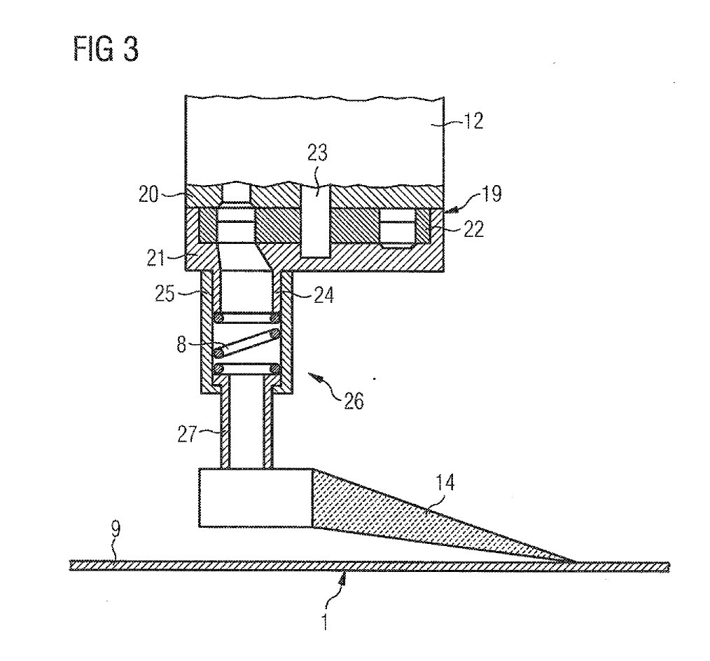

FIG. 3 is a fuel pump 12 together with the pump housing 19 which comprises a pump base 20 and a pump cover 22. The impeller 22 which is driven by the shaft 23 of an electric motor (not illustrated) of the fuel pump 12 is arranged in the pump housing 19. The pump cover 21 has a step 24 to which the first element 25 of the intake tube 26 is fastened. The first element 25 is adjoined by a second movable element 27 which is movable axially relative to the first element 25. The movable element 25 is pressed downward via a compression spring 8 arranged between the pump cover 21 and the movable element 27. As a result of said movement, the preliminary filter 14 which is arranged on the movable element 27 is prestressed against the base 9 of the fuel tank 1. The fuel pump 12 can therefore deliver fuel from the lowest intake point to the internal combustion engine.

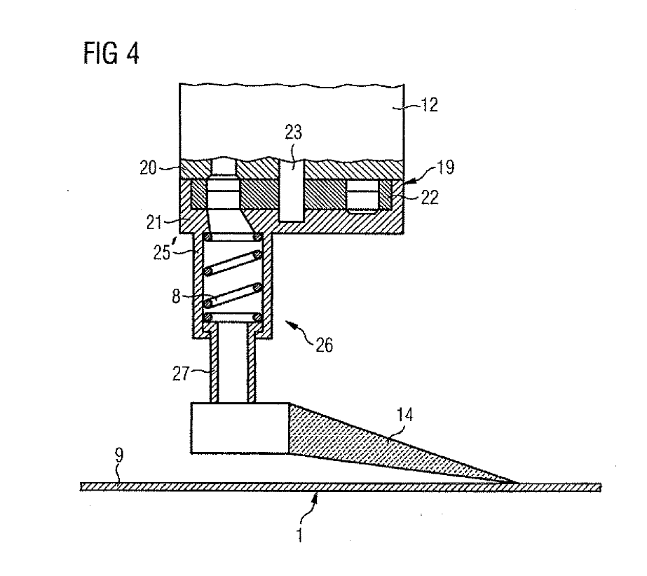

FIG. 4 is a fuel pump 12 which differs in construction from the fuel pump according to FIG. 3 in that the first element 25′ of the intake tube 26 is formed integrally with the pump cover 21.

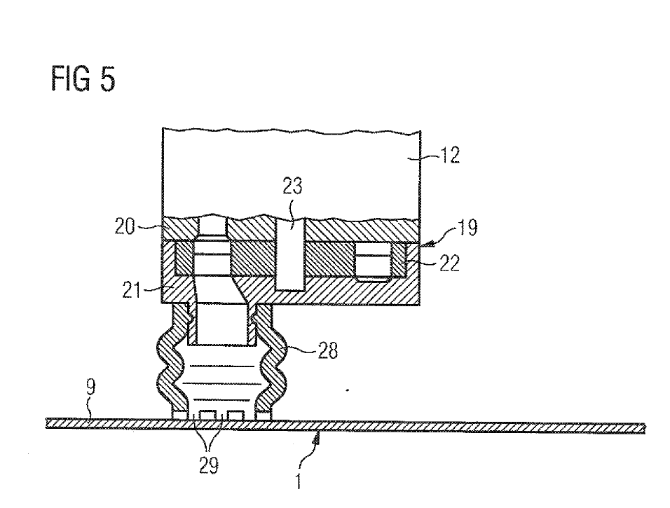

FIG. 5 is a fuel pump 12 with an intake tube designed as an expansion bellows 28. The expansion bellows 28 is composed of polyimide. The axial length of the expansion bellows 28 is greater in the unloaded state than in the installed position illustrated. This ensures that the geometry of the expansion bellows 28 is prestressed at its lower end against the base 9 of the fuel tank 1. Owing to its changeable axial length, the expansion bellows 28 permits compensation of tolerances and filling-level-dependent sagging of the base 9. In order to ensure that fuel is drawn up, that end of the expansion bellows 28 which faces away from the fuel pump 12 has axially arranged formations 29 which are distributed at a distance from one another over the circumference of the expansion bellows 28. The distances between the formations 29 form openings through which the fuel can be drawn up by the fuel pump 12.

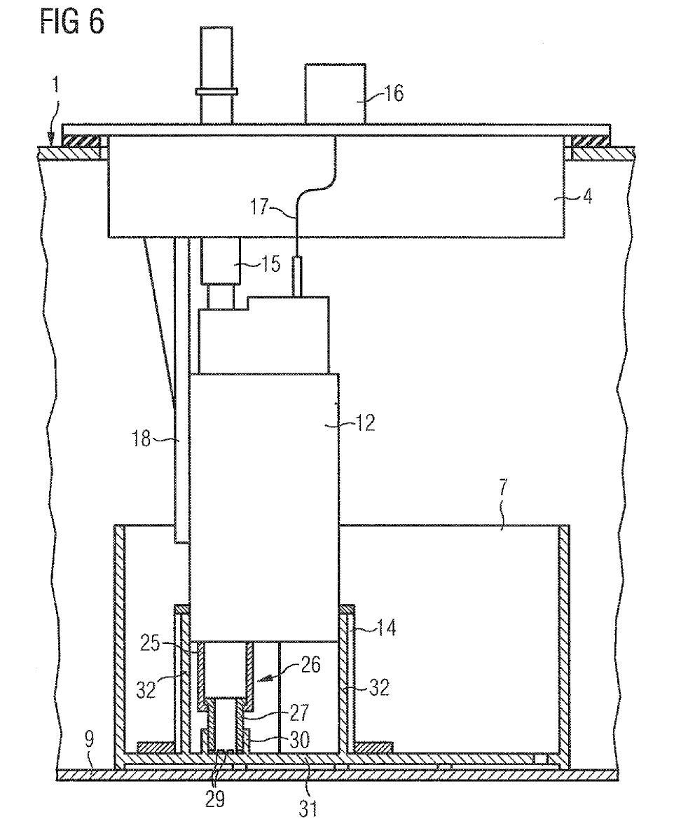

The fuel pump 12 shown in FIG. 6 is preferably connected in a positionally unchangeable manner to the flange 4 via a pump holder 18. The fuel pump 12 reaches with its lower region into a swirl pot 7. The swirl pot 7 is fixedly connected to the base 9 of the fuel tank 1. The swirl pot 7 contains webs 32 which are integrally formed on the base 31 and are oriented vertically. The webs 32 form a support for the cylindrical preliminary filter 14 which is arranged on the outside around the webs 32. In the second function, the webs 32 serve to positionally fix the fuel pump 12. Furthermore, a receptacle 30 composed of preferably four vertically arranged webs is fastened to the base 31 of the swirl pot 7. The movable element 27 of the intake tube 26 is pressed into said receptacle 30. Owing to the press fit and the associated direct connection to the base 31, a spring is not necessary for prestressing the movable element 27. The movable element 27 is displaced axially in the first element 25 directly by the base 9 when the sagging of the base 9 changes as a result of a changing filling level. The fuel drawn up by the fuel pump 12 flows through the spaced-apart webs of the receptacle 30 to the movable element 27. Since that end of the movable element 27 which faces away from the fuel pump 12 has axially protruding formations 29 which are spaced apart from one another, the fuel passes into the fuel pump 12 through the gaps formed by in each case two adjacent formations 29.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A fuel pump comprising:
an electric motor; and
a pump stage configured to be driven by the electric motor, comprising:
a pump housing comprising:
a pump base; and
a pump cover;
an intake tube configured to be changeable in its axial length coupled to the pump cover; and
an impeller arranged in the pump housing.

9. The fuel pump as claimed in claim 8, wherein the intake tube comprises an expansion bellows.

10. The fuel pump as claimed in claim 8, wherein the intake tube comprises:
a first fixed element; and
a second element, the second element arranged in an axially movable manner with respect to the first element.

11. The fuel pump as claimed in claim 10, wherein the second element is at least one of metal and plastic.

12. The fuel pump as claimed in claim 10, further comprising a compression spring arranged in the intake tube between the pump cover and the second element.

13. The fuel pump as claimed in claim 10, wherein the second element is configured to be fixedly connected to at least one of a base of a fuel tank and a base of a swirl pot.

14. The fuel pump as claimed in claim 10, wherein at least one of an end of the second element and the expansion bellows that faces away from the fuel pump comprises axially arranged formations distributed at a distance from one another over a circumference of the second element.

15. The fuel pump as claimed in claim 13, wherein the second element is configured to be fixedly connected by at least one of a press fit and clip connection.

16. The fuel pump as claimed in claims 12, wherein the second element is configured to be fixedly connected to at least one of a base of a fuel tank and a base of a swirl pot.

17. The fuel pump as claimed in claim 16, wherein the second element is configured to be connected by at least one of a press fit connection and a clip connection.

18. The fuel pump as claimed in claim 13, wherein an end of the second element that faces away from the fuel pump comprises axially arranged formations distributed at a distance from one another over a circumference of the second element.

19. The fuel pump as claimed in claim 9, wherein at least one of an end of the expansion bellows that faces away from the fuel pump comprises axially arranged formations distributed at a distance from one another over a circumference of the expansion bellows.
